(19) United States
(12) Patent Application Publication
(10) Pub. No.: US 2022/0061582 A1
(43) Pub. Date: Mar. 3, 2022

(54) MACHINE FOR EXTRACTION OF BEVERAGE

(71) Applicant: PHUSION CO., LTD., Tainan City (TW)

(72) Inventors: Kai-Cheng CHANG, Tainan City (TW); Wei-Te LEE, Tainan City (TW)

(73) Assignee: PHUSION CO., LTD., Tainan City (TW)

(21) Appl. No.: 17/400,362

(22) Filed: Aug. 12, 2021

(30) Foreign Application Priority Data
Aug. 25, 2020 (TW) 109128880

(51) Int. Cl. A47J 31/38; A47J 31/46; A47J 31/44; A47J 31/52

(52) U.S. Cl. CPC A47J 31/38; A47J 31/5251; A47J 31/4403; A47J 31/461

(57) ABSTRACT

A machine for extraction of beverage comprising a driving unit, a storage unit and a transfer unit is disclosed. The storage unit connects with the driving unit. The transfer unit comprises a multi-way valve assembly that comprises a first end, a second and a third end. The first end is used to connect with a container holding a solvent, the second end connects with the storage unit, and the third end connects with an extraction unit. When the multi-way valve assembly is under a first state, the solvent is driven by the driving unit to flow between the first end and the storage unit. The solvent is driven by the driving unit and then to flow between the storage unit and the third end when the multi-way valve assembly is under a second state.

### CROSS-REFERENCE TO RELATED PATENT APPLICATION

This patent application claims the benefit of Taiwan (R.O.C.) Application No. 109128880 filed on Aug. 25, 2020. The above application is incorporated by reference herein.

### FIELD OF THE DISCLOSURE

The present disclosure relates generally to the field of machines for extraction of beverage, and more particularly to machines for extraction of beverage that may cyclically heat a solvent.

### BACKGROUND

Due to the ubiquity of coffee, there are many types of coffee machines provided on the market to fulfill various needs of the users. With the advancement of manufacturing process and technology, both semi-automatic coffee machines and fully automatic coffee machines were developed with continuous evolutions and improvements. For some businessmen or consumers, semi- or fully-automatic coffee machine will certainly be a favorable choice on considering working efficiency of brewing, labor cost and convenience of operation are considered.

However, in the professional field related to coffee, especially for baristas, coffeeholic, etc., if a cup of coffee is made by semi- or fully-automatic machine, the aroma, taste, and flavour of coffee is usually limited by the brewing process performed by the automatic machines mechanically and hence, it is difficult to bring out the unique flavour of each cup of coffee.

For coffeeholics, they not only enjoy tasting coffee but also enjoy each brewing process of coffee. Because various factors such as the grinding speed, the grind size, the tamping pressure, the grind uniformity, the water temperature, the brewing time, and the extraction pressure would affect the flavour of coffee, each step during the brewing process including selecting beans, grinding, tamping, blooming coffee to extraction is crucial to the flavour of each drop of the brewed coffee. Under such circumstances, brewing coffee manually is certainly more meaningful than automatic brewing.

The conventional manual coffee machine generally uses a lever to cooperate with a piston assembly to extract coffee. For example, Taiwan utility model patent entitled “Modified Coffee Brewer” with patent number M486369 (hereinafter referred to as “Prior Art 1”) disclosed that a user may drive the piston assembly by manually lifting the lever to create a suction. With the suction exerted by said piston assembly, liquid in a container may be drained and then flow into a cylinder. Subsequently, the user may manually pull down said lever to create a downward pressure which may force said liquid to pass through the coffee powder so as to complete the extraction step.

However, Prior Art 1 has the following problems: (1) Once the extraction process is not performed immediately after the heated liquid is transferred to the cylinder, the temperate of the heated liquid will decrease over time. Therefore, the extraction process may not be performed under an ideal temperature, which would affect the yield and quality of the extraction process; (2) During the extraction process, the pressure applied to the lever varies between different users. It means that once the force is applied improperly or once the piston has any breakage or crack, the liquid in the machine is likely to splash under high pressure. In addition, because the piston assembly is disposed on the upper side of the cylinder and penetrates the top end of the cylinder, when the liquid splash from the opening on the top end of the cylinder, it may cause a more severe burn injury to the user's face; (3) An ideal pressure for extracting coffee is about 9 bars. Although using a lever to control the piston may amplify the force applied by the user in accordance with Principles of Levers, such degree of amplification is still limited and depends on the length of the lever. Accordingly, the user must put lots of effort for operating the lever to create such a high pressure, which render the extraction process laborious and inconvenient.

It should be noted that the inadequacies mentioned above are not only exist in Prior Art 1, but also commonly exist in lever coffee machines on the market.

Accordingly, there is a need to provide a manual coffee machine which may maintain an ideal temperature of liquids for the extraction process to ensure the yield and quality of the brewed coffee, to prevent hazards caused by an accidental solvent splashes, and to solve the problem of the laborious extraction process.

### SUMMARY

In response to the above-referenced inadequacies, the present disclosure provides a machine for extraction of beverage comprising a driving unit, a storage unit and a transfer unit. The storage unit connects with the driving unit. The transfer unit comprises a multi-way valve assembly, wherein the multi-way valve assembly comprises a first end, a second and a third end. The first end is used to connect with a container which is used to hold a solvent; the second end connects with the storage unit; the third end is used to connect with an extraction unit which can hold an extract. When the multi-way valve assembly is under a first state, the solvent is driven by the driving unit to flow between the first end and the storage unit; and when the multi-way valve assembly is under a second state, the solvent is driven by the driving unit and then to flow between the storage unit and the third end.

In some embodiments, the driving unit comprises a lever, a transfer assembly and a piston assembly, wherein the lever is configured to be held by a user to drive the solvent to flow within the transfer unit.

In some embodiments, the transfer assembly further comprises a first transmission element and a second transmission element meshing with the first transmission element.

In some embodiments, both the first transmission element and the second transmission element are gears, and a pitch diameter of the first transmission element is shorter than a pitch diameter of the second transmission element.

In some embodiments, the storage unit comprises a first opening and a second opening, and the piston assembly penetrates the second opening.

In some embodiments, the machine for extraction of beverage further comprises a base, wherein, compared to the second opening, the first opening is located on the one side of the storage unit away from the base.

In some embodiments, a direction of movement of the piston assembly and the base are perpendicular to each other.

In some embodiments, the machine for extraction of beverage further comprises a pressure gage disposed adjacent to the third end.

In some embodiments, the multi-way valve assembly further comprises a multi-way valve and a multi-way tube, wherein, the multi-way valve is disposed in the multi-way tube, and the multi-way tube is connected with at least one of the first end, the second end, and the third end by a tubular member.

In some embodiments, the multi-way tube is a three-way pipe.

In some embodiments, the container is an Erlenmeyer flask.

The present disclosure further provides a machine for extraction of beverage in another embodiment comprising a transfer unit and a driving unit. The transfer unit includes a first end, a second end and a third end. The first end is used to connect with a container which is used to hold a solvent. The second end connects with the storage unit. The third end is used to connect with an extraction unit which can hold an extract. The driving unit connects with the storage unit and includes a lever, transfer assembly and a piston assembly. The lever is configured to be held by a user to drive the solvent to flow within the transfer unit. The transfer assembly comprises a first transmission element and a second transmission element meshing with the first transmission element.

In some embodiments, both the first transmission element and the second transmission element are gears, and a pitch diameter of the first transmission element is shorter than a pitch diameter of the second transmission element.

In some embodiments, the storage unit comprises a first opening and a second opening, and the piston assembly penetrates the second opening.

In some embodiments, the machine for extraction of beverage further comprises a base wherein compared to the second opening, the first opening is disposed on the one side of the storage unit farther away from the base.

In some embodiments, the direction of movement of the piston assembly and the base are perpendicular to each other.

In some embodiments, the machine for extraction of beverage further comprises a pressure gage which disposed adjacent to the third end.

In some embodiments, the container is an Erlenmeyer flask.

In Sum, the present disclosure provides a machine for extraction of beverage which allows a solvent to selectively flow back and forth between the container and the storage unit, or allows a solvent to selectively flow back and forth between the storage unit and the extraction unit by the use of the multi-way valve assembly, so that the machine for extraction of beverage may achieve the object of providing an ideal extraction temperature while using a limited amount of solvent which is heated repeatedly, thereby increasing the conveniency and reducing the cost of the extraction process.

To be specific, the present disclosure amplifies the force exerted by a user in accordance with Principles of Levers by the use of a lever, a first transmission element, and a second transmission element so as to solve the problem of laborious extraction step. In addition, the present disclosure reduces the pressurization rate and the drawing rate of the solvent to appropriate values by the use of two meshing gears having different gear rates.

Besides, some of the conventional manual coffee machines on the market use devices similar to pumps as power sources. In such cases, in order to allow the heated water to achieve a higher extraction efficacy, about 9 bars of pressure must be exerted. However, under such a high pressure, once the gasket in the cylinder gets aged, oxidized, embrittled or loose, it may cause liquid splash. In the present disclosure, the storage unit and the piston assembly together constitute a device similar to a pump, and because the opening of the storage unit penetrated by the piston assembly is configured to be facing the ground the piston assembly penetrates and moves through the bottom of the storage unit. Therefore, the hazards caused by heated liquid splashing from the top side of the storage unit may be prevented if there is an inattentive pressurization process or any breakage on the piston seal.

Furthermore, the machine for extraction of beverage may further comprises a pressure gage adjacent to the third end so as to control the ideal extraction pressure more precisely.

### BRIEF DESCRIPTION OF THE DRAWINGS

FIG. 1A is a schematic perspective view of the machine for extraction of beverage in one embodiment of the present disclosure.

FIG. 1B is a schematic perspective view of the machine for extraction of beverage in one embodiment of the present disclosure.

FIG. 2 is a schematic exploded view of the machine for extraction of beverage in one embodiment of the present disclosure.

FIG. 3 is a schematic side view of the machine for extraction of beverage in one embodiment of the present disclosure.

FIG. 4 is a schematic front view of the machine for extraction of beverage in one embodiment of the present disclosure.

FIG. 5A is a schematic view of the machine for extraction of beverage in one embodiment of the present disclosure illustrating a using state.

FIG. 5B is a schematic view of the machine for extraction of beverage in one embodiment of the present disclosure illustrating a using state.

FIG. 6A is a schematic view of the machine for extraction of beverage in one embodiment of the present disclosure illustrating a using state.

FIG. 6B is a schematic view of the machine for extraction of beverage in one embodiment of the present disclosure illustrating a using state.

FIG. 7 is a schematic view of the machine for extraction of beverage in one embodiment of the present disclosure illustrating a using state.

### DETAILED DESCRIPTION

The machine for extraction of beverage in the preferred embodiments of this disclosure are described below with reference to the relevant drawings, and identical or similar numerals in the drawings indicate identical or similar components or steps throughout the views.

It is important to note that all directional terms in the embodiments of this disclosure (such as upper, lower, left, right, front, and back) are used only to explain the relative positional relationship, movement condition, and the like between components in a particular state (as shown in the accompanying drawings), and if the particular state changes, the directional terms will change accordingly.

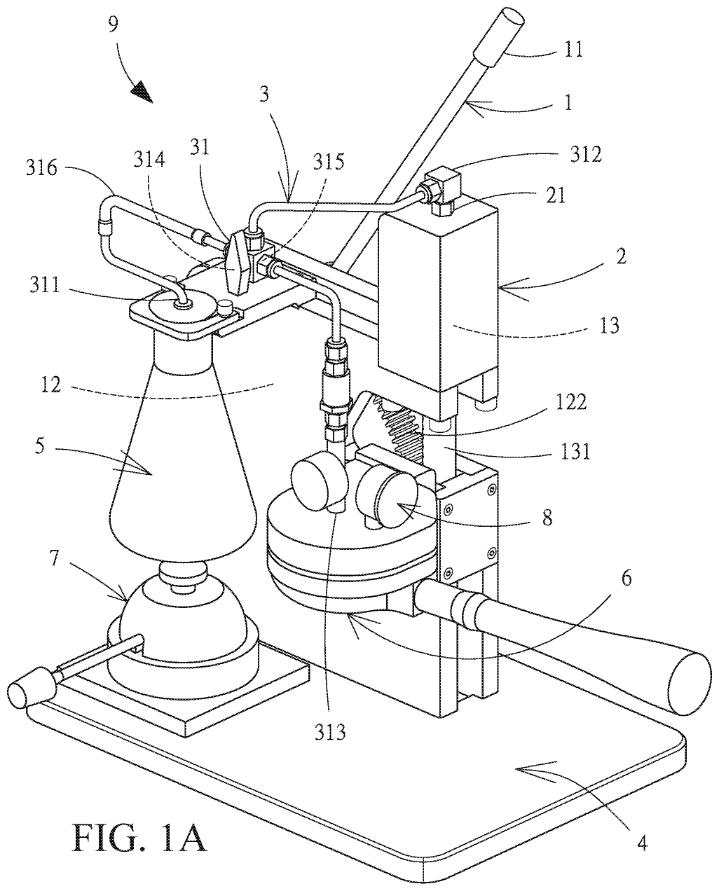

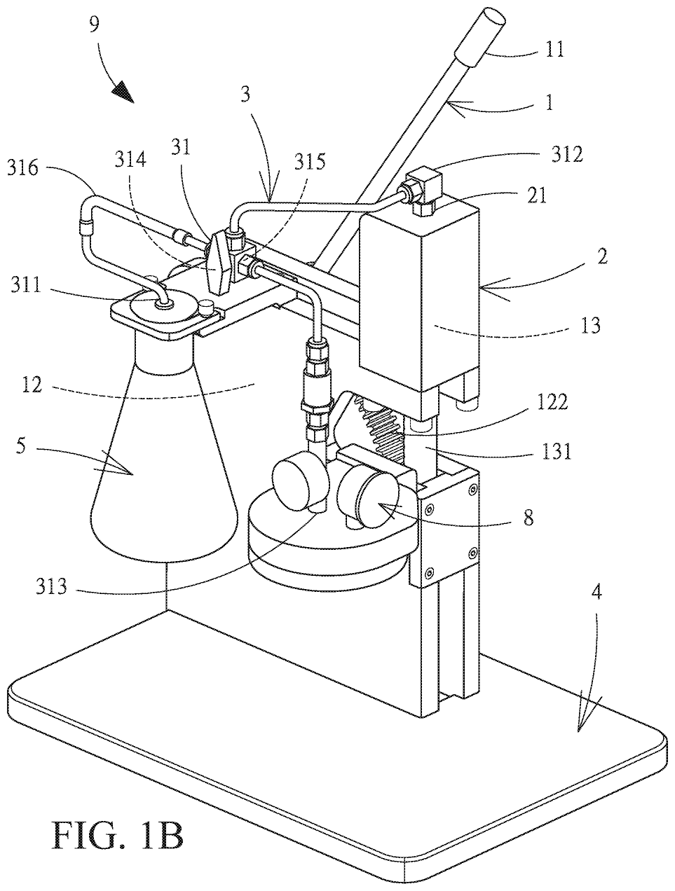

As shown in FIG. 1A to FIG. 7, in the present embodiment, the machine for extraction of beverage 9 is a coffee machine.

As shown in FIG. 1A to FIG. 4, in some embodiments, the machine for extraction of beverage 9 comprises a driving unit 1 which is configured to be a power source of the machine for extraction of beverage 9. In some embodiments, the driving unit 1 provides operational energy by manpower including a lever 11, a transfer assembly 12 and a piston assembly 13, wherein the lever 11 is configured to be an operation terminal allowing a user to hold and apply force. The lever 11 connected with the transfer assembly 12 may drive the piston assembly 13 connected with the transfer assembly 12.

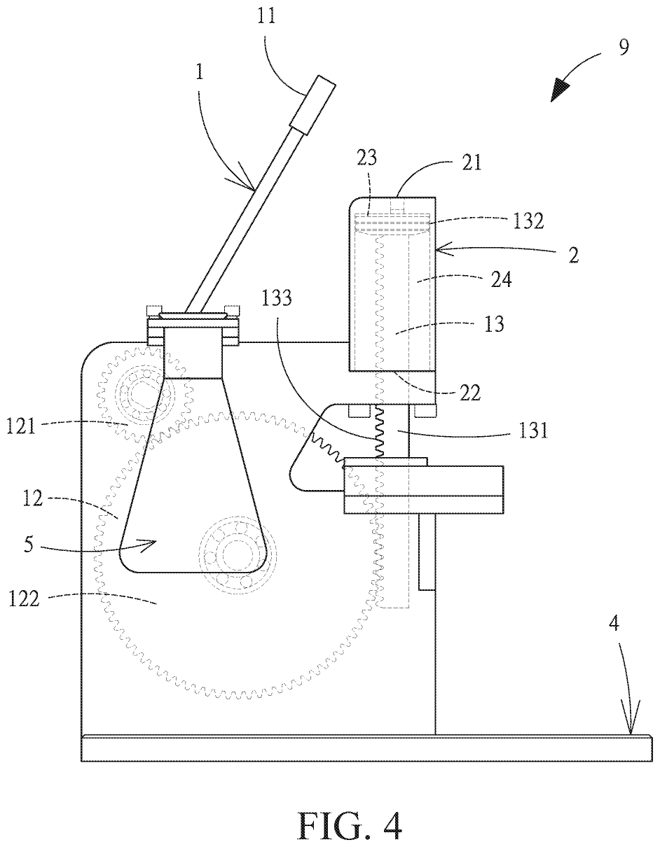

As shown in FIG. 4, in some embodiments, the transfer assembly 12 further comprises a first transmission element 121 and a second transmission element 122 mesh with each other. In the present embodiment, both the first transmission element 121 and the second transmission element 122 are gears, and the pitch diameter of the first transmission element 121 is smaller than the pitch diameter of the second transmission element 122, and the teeth on their outer edges mesh with each other.

As shown in FIG. 4, in the present embodiment, the lever 11 connects with the first transmission element 121 driving both of them to rotate coaxially, and the rotating direction of the first transmission element 121 depends on the operating direction of the lever 11. When the first transmission member 121 with a smaller size rotates, the second transmission element 122 with a larger size will be driven to rotate inversely, so that the benefit of labor-saving in accordance with Principle of lever may be achieved.

It should be noticed that different from the conventional manual coffee machine, the present disclosure not only amplifies the force exerted by a user in accordance with Principle of lever but also further amplifies the force by driving a large gear by a small gear (i.e., the first transmission element 121 may drive the second transmission element 122) to solve the problem of laborious extraction step of the conventional manual coffee machine.

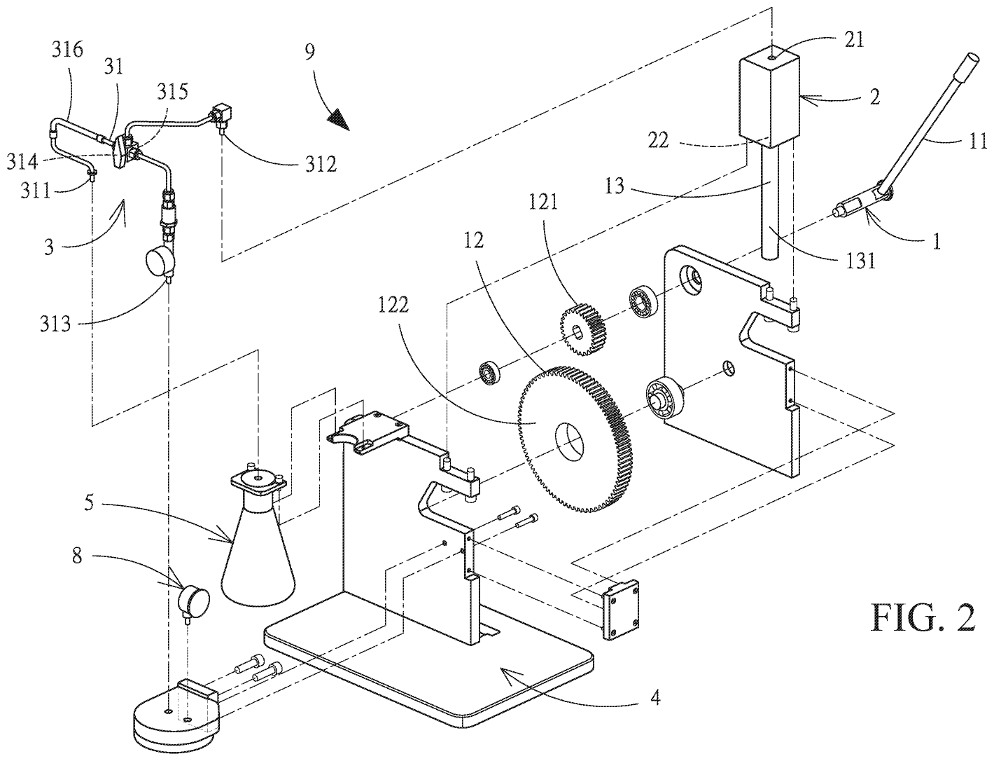

As shown in FIG. 1A to FIG. 2, in some embodiments, the machine for extraction of beverage 9 further comprises a storage unit 2. The storage unit 2 connected with the driving unit 1 is used to hold a solvent and is used to cooperate with the movement of the piston assembly 13 inside its chamber to create a pressure. The mechanism will be described in detail in the subsequent paragraphs.

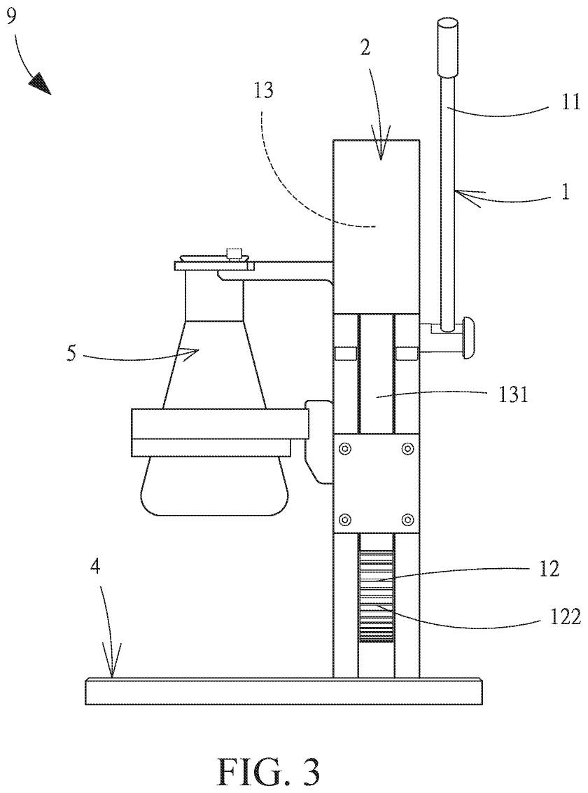

As shown in FIG. 3 and FIG. 4, in some embodiments, the machine for extraction of beverage 9 further comprises a base 4. The base 4 is used to hold each component of the machine for extraction of beverage 9 and provide a contact surface between the machine for extraction of beverage 9 and the position where it places.

As shown in FIG. 4, in some embodiments, the storage unit 2 further comprises a first opening 21 and a second opening 22. Compared to the second opening 22, the first opening 21 is located on a side of the storage unit 2 away from the base 4. In the present embodiment, the first opening 21 and the second opening 22 are located on different sides of the storage unit 2 respectively, and compared to the second opening 22, the first opening 21 is away from the base 4; i.e., when the machine for extraction of beverage 9 is placed upright, the height above the horizontal plane of the first openings 21 is larger than the height above the horizontal plane of the second openings 22, and the first opening 21 and the second opening 22 are openings at the top end and the bottom end of the storage unit 2, respectively.

As shown in FIG. 4, in some embodiments, the piston assembly 13 penetrates the second opening 22. In some embodiments, the direction of movement of the piston assembly 13 and the base 4 are perpendicular to one another. In some embodiments, the piston assembly 13 includes a connecting rod 131 and a sealing element 132. In the present embodiment, the piston assembly 13 is configured as a cylinder with its axial direction perpendicular to the base 4. The piston assembly 13 connects the sealing element 132 and may drive the piston assembly 13 to move along the direction of the normal vector of the base 4.

In the present embodiment, the sealing element 132 is restrained in the storage unit 2 and disposed on the side of the piston assembly 13 away from the base 4. The outer edge of the sealing element 132 is slidably connected to the inner wall of the chamber of the storage unit 2 and divides the chamber of the storage unit 2 into two parts—a first chamber 23 and a second chamber 24, thereby effectively preventing a fluid moving from the first chamber 23 to the second chamber 24.

As shown in FIG. 4, in the present embodiment, the connecting rod 131 is engaged with a gear rack 133, and the gear rack 133 meshes with the second transmission element 122. As mentioned above, the transfer assembly 12 connects with the piston assembly 13 and may drive the piston assembly 13. In the present embodiment, when the second transmission element 122 rotates, the gear rack 133 is driven to move, and the direction of movement of the piston assembly 13 (i.e., clockwise, or counterclockwise) depends on the rotating direction of the second transmission element 122 (i.e., upward, or downward). The mechanisms between the piston assembly 13 and other components, and the advantages that may be achieved will be described in detail in accordance of with specific embodiments in the subsequent paragraphs.

As shown in FIG. 1A to FIG. 2, in some embodiments, the machine for extraction of beverage 9 further comprises a transfer unit 3. The transfer unit 3 includes a multi-way valve assembly 31. In some embodiments, the multi-way valve assembly 31 comprises a first end 311, a second end 312 and a third end 313.

In some embodiments, the first end 311 is used to connect with a container 5, and the container 5 is used to hold a solvent (not shown). The container 5 may be, for example but not limited to, an Erlenmeyer flask, a beaker, a steel cup, a measuring glass, or a porcelain cup. In the present embodiment, the container 5 is an Erlenmeyer flask, and the solvent is water.

In some embodiments, the second end 312 connects with the storage unit 2 and may be in communication with either the first end 311 or the third end 313.

In some embodiments, the third end 313 is used to connect with an extraction unit 6 (as shown in FIG. 1A). The extraction unit 6 may be a device that has functions of filtration and extraction, for example but not limited to, a portafilter with or without a bottom. The extraction unit 6 is used to hold an extract (not shown), and the extract may be, for example but not limited to, petals, herbs, spices, tea leaves, or coffee powders. In the present embodiment, the extraction unit 6 is selected from a portafilter with a standard size made of wood, and the extract is coffee powders.

As shown in FIG. 1A, in some embodiments, the multi-way valve assembly 31 further comprises a multi-way valve 314 and a multi-way tube 315. The multi-way valve 314 is disposed in the multi-way tube 315, and the multi-way tube 315 is connected with at least one of the first end 311, the second end 312 and the third end 313 by a tubular member 316. Namely, in some embodiments, based upon different arrangements between the components, the multi-way tube 315 may be connected to a tubular member 316 for engaging the multi-way tube 315 with the first end 311, the second end 312 and the third end 313. As shown in FIG. 1A, in the present embodiment, the first end 311 connects with the multi-way tube 315 by the tubular member 316.

As shown in FIG. 1A, in the present embodiment, the multi-way tube 315 is a three-way pipe which provides a transport path for the solvent. The multi-way valve 314 is disposed in the multi-way tube 315, and the three-way pipe may be switched between different connected states. The details regarding the different connected states will be described in accordance with specific embodiments in the subsequent paragraphs.

The use of the machine for extraction of beverage 9 and the mechanisms between the components thereof are described herein.

First, a heating apparatus 7 (i.e., an alcohol burner or a gas stove, such as, but not limited) is provided to heat the container 5 which has been filled with the solvent (in the present embodiment, the solvent is water, which is not shown). The extraction unit 6 (as shown in FIG. 1A, in the present embodiment, the extraction unit 6 is a portafilter that has been filled with the coffee powders that are already grinded and tamped) is provided and connected to the third end 313 before or while heating the solvent. Next, the water is introduced into the machine for extraction of beverage 9 and the extraction step is performed (the details of this step will be further illustrated in the subsequent paragraphs) after the solvent reaches an ideal temperature (in some embodiments, the ideal temperature is between 80° C. and 95° C., however, the ideal temperature is not limited in the present disclosure).

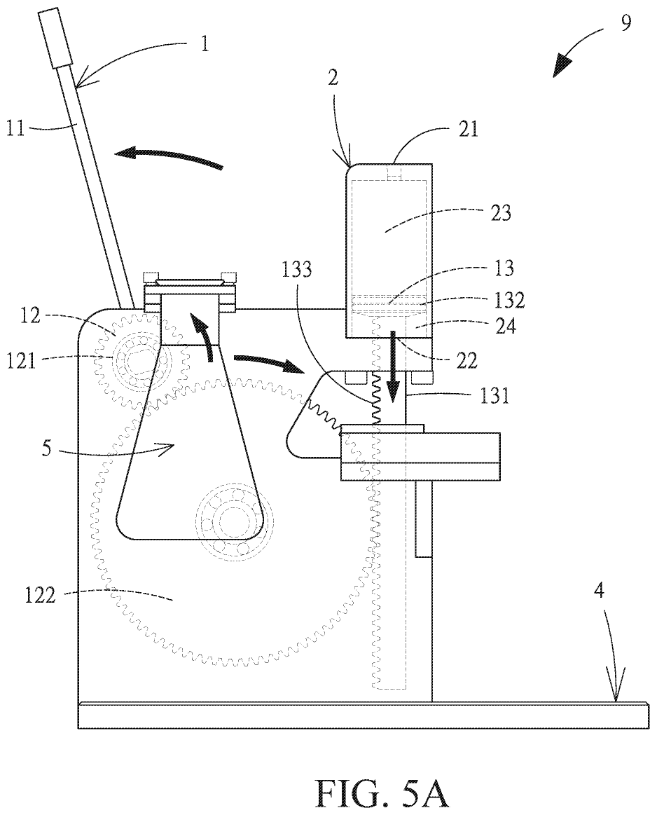

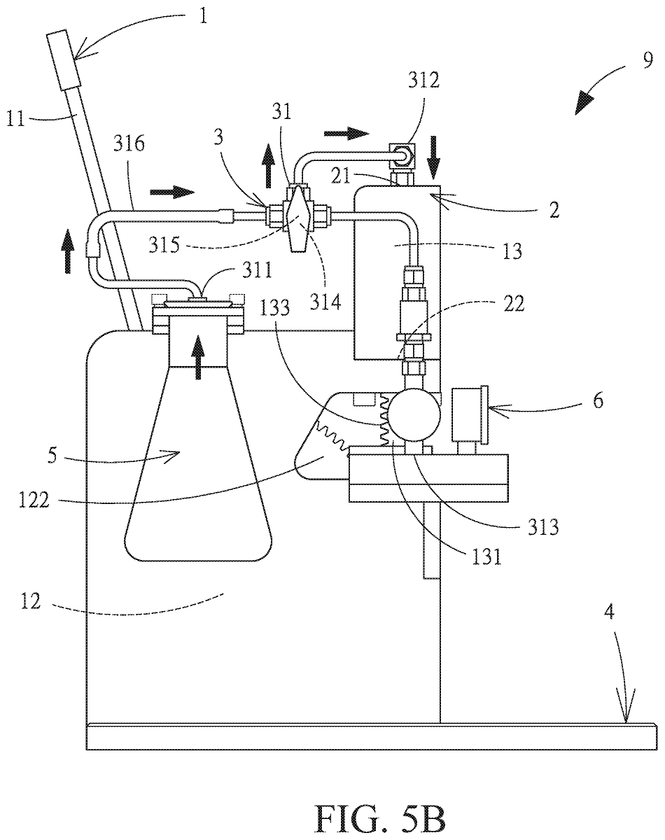

As shown in FIGS. 5A-7, in some embodiments, when the multi-way valve assembly 31 is under a first state, the solvent is driven by the driving unit 1 and flows back and forth between the first end 311 and the storage unit 2; and when the multi-way valve assembly 31 is under a second state, the solvent is driven by the driving unit 1 and flows back and forth between the storage unit 2 and the third end 313.

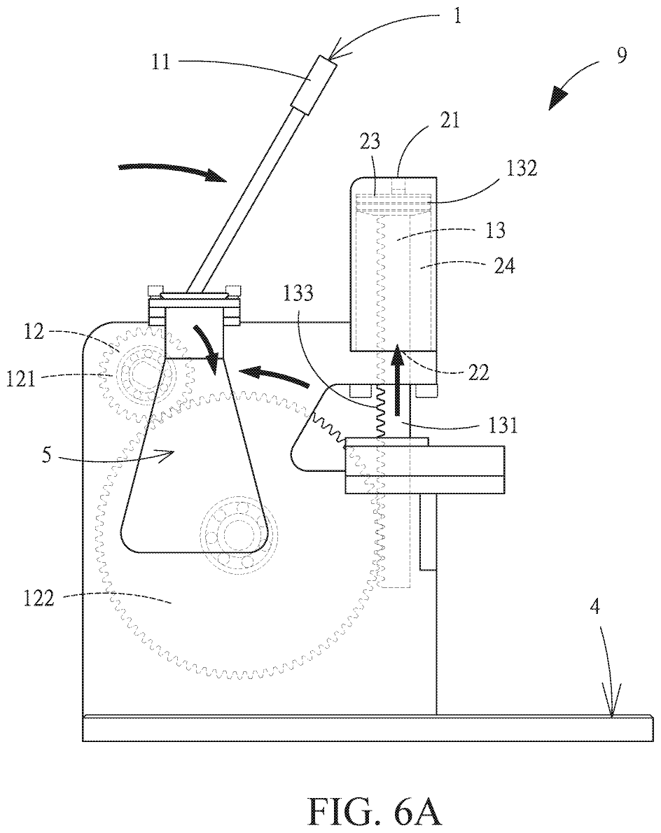

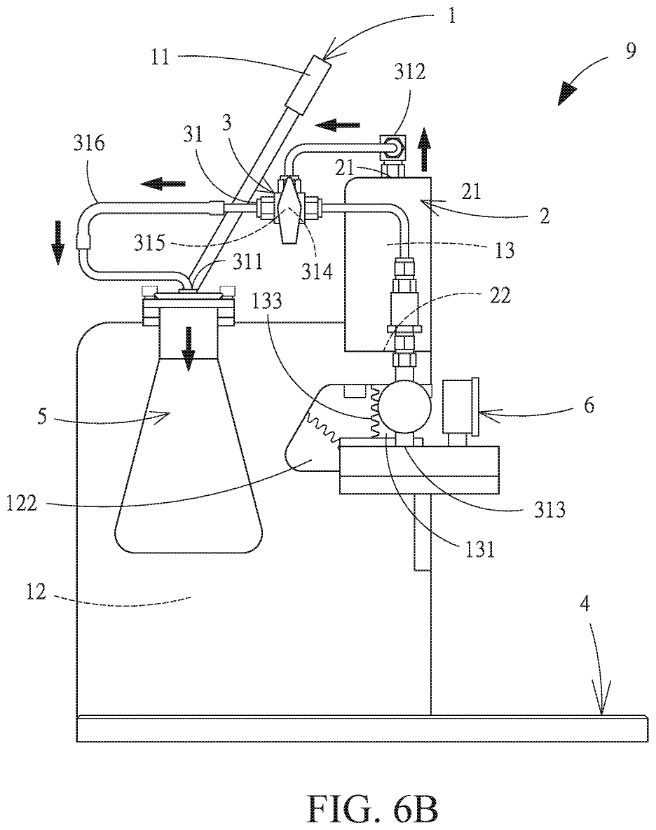

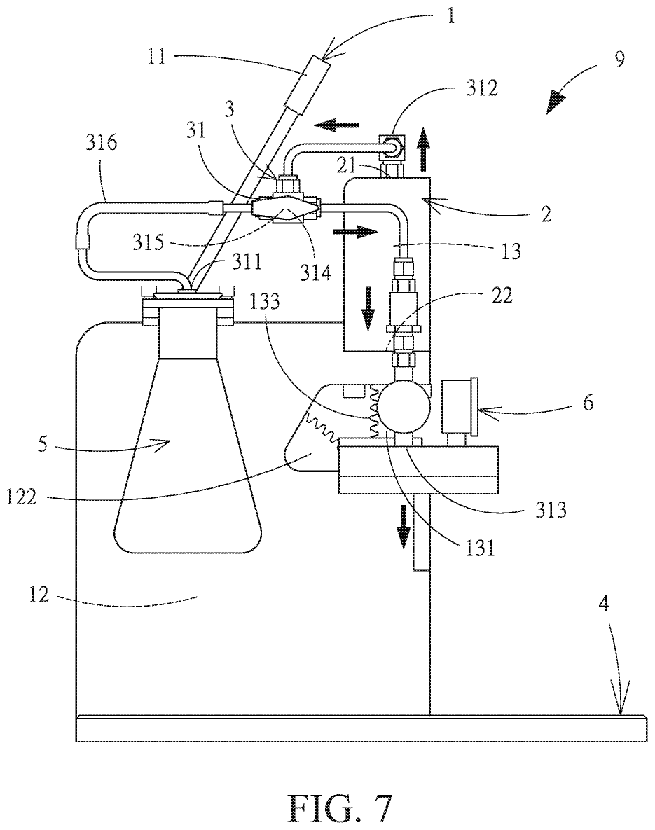

FIG. 5A to FIG. 6B are schematic views illustrating the multi-way valve assembly 31 under the first state; FIG. 7 is a schematic view illustrating the multi-way valve assembly 31 under the second state. It should be noted that the transfer unit 3 is omitted in FIGS. 5A and 6A to clearly illustrate the mechanism between the transfer assembly 12 and the piston assembly 13. Because FIG. 5A and FIG. 5B illustrate the same state, and FIG. 6A and FIG. 6B illustrate another same state, these two sets of Figures may be referred to accordingly.

The first state and the second state are described sequentially thereafter.

[The First State]

The multi-way valve 314 is operated to allow the transfer unit 3 to be under a state that the first end 311 is in communication with the second end 312, and the second end 312 is not in communication with the third end 313.

As shown in FIG. 5A and FIG. 5B, in the present embodiment, when the user operates the lever 11 in a direction away from the storage unit 2 (as shown in FIG. 5A, the lever 11 rotates counterclockwise), the transfer assembly 12 is driven to move accordingly (as shown in FIG. 5A, the first transmission element 121 rotates counterclockwise, and the second transmission element 122 rotates clockwise), and the piston assembly 13 is driven to move downward. At the same time, the volume of the first chamber 23 increases and the pressure of the first chamber 23 decreases, so that a suction is created to introduce the solvent from the container 5 into the storage unit 2 through the transfer unit 3.

As shown in FIG. 6A and FIG. 6B, in the present embodiment, when the user drives the lever 11 in a direction towards the storage unit 2 (as shown in FIG. 6A, the lever 11 rotates clockwise), the transfer assembly 12 is driven to move accordingly (as shown in FIG. 6A, the first transmission element 121 rotates clockwise, and the second transmission element 122 rotates counterclockwise), and the piston assembly 13 is driven to move upward. At the same time, the pressure in the first chamber 23 increases, so that the solvent that has been introduced into the storage unit 2 flows back to the container 5 through the transfer unit 3.

According to the steps described above, the user may controllably enable the solvent to flow back and forth between the container 5 and the storage unit 2 through the transfer unit 3. In this way, the solvent may be heated repeatedly so as to solve the problem that the conventional manual coffee machines unable to maintain the solvent under an ideal temperature which deleteriously affects the yield and quality of extraction.

[The Second State]

The multi-way valve 314 is operated to allow the transfer unit 3 to be under a stage that the second end 312 is in communication with the third end 313, and the second end 312 is not in communication with the first end 311.

As shown in FIG. 7, in the present embodiment, the lever 11 rotates in a direction towards the storage unit 2, and the pressure in the storage unit 2 increases according to the mechanism described above. At the same time, the solvent in the storage unit 2 is transferred to the third end 313, and said pressure is conveyed via a liquid (herein referred to as the solvent) to the extraction unit 6 (as shown in FIG. 1A) for providing an extraction pressure.

In some embodiments, after the extraction step is completed, the user may operate the lever 11 in a direction away from the storage unit 2 according to the mechanism described above, so that the storage unit 2 create a suction which may re-introduce the solvent that has not been used and remained on the path from the storage unit 2 to the third end 313 into the storage unit 2 to be stored. Furthermore, the multi-way valve assembly 31 may be further switched to the first state to allow the solvent to flow back to the container 5 and to be re-heated according to the needs of the users.

As shown in FIG. 7, in some embodiments, the machine for extraction of beverage 9 further comprises a pressure gage 8 used to measure or control the extraction pressure. In some embodiments, the pressure gage 8 is disposed adjacent to the second end 312 or the third end 313. In particular, the position of the pressure gage 8 described above (as shown in FIG. 1A) may avoid the pressure drop due to length of the transport route. To be specific, when the pressure gage 8 is further away from the extraction unit 6, there is a large difference between the ideal extraction pressure and the actual pressure provided.

The technical features of the present disclosure, which is different from the conventional manual coffee machines, and the problems that it may solve are summarized herein:

(1) In the professional field related to coffee brewing, the flavour of coffee differs under various conditions, for example, using the same coffee bean for brewing under different temperatures or using different coffee beans for brewing under the same temperature. Because the components, the pipeline, etc. inside the coffee machine each has different specific heat, the temperature (for example, T degree) of the hot water from a container (bottle, etc.) will drop when it is introduced into the portafilter after passing through the pipeline, the components, etc. (e.g. the temperature of the hot water will be lower than T degree). Therefore, it is difficult for the user to know the extraction temperature. Because the conventional manual coffee machines do not have a recirculating-heating system, most of the users choose to continuously heat the water to allow hot water of T degree continuously passing through the pipeline and the device, thereby ensuring the extraction temperature to be T degree. However, such approach not only wastes water but also has the problem that the coffee machines cannot be preheated if there is no additional container to receive the water poured from the output port. In the present disclosure, the solvent may flow back and forth between the first end 311 and the second end 312 or between the third end 313 and the second end 312 through the transfer unit 3 according to actual needs based on the specific structural design of the machine. Therefore, the problem that the conventional manual coffee machines cannot allow the solvent to be heated repeatedly to keep the solvent under an ideal temperature and deleteriously affects the yield and quality of extraction may be solved.

(2) Some of the conventional manual coffee machines on the market use devices similar to pumps as power sources. In such cases, in order to allow the heated water to achieve a higher extraction efficacy, about pressure must be exerted. However, under such a high pressure, once the gasket in the cylinder gets aged, oxidized, embrittled or loose, it may cause liquid splash which causes a hazard to the user. Moreover, in many situations, the devices similar to pumps are often made from opaque materials, e.g., metal, which does not allow the users to identify whether the gasket gets aged, oxidized, embrittled or loose from the outside of the storage unit. In the same way, in the present disclosure, the storage unit 2 and the piston assembly 13 together constitute a device similar to a pump. Although the storage unit 2 is made from stainless steel in some embodiments of the present disclosure, the opening of the storage unit penetrated by the piston assembly is configured facing the ground, so that once there is an inattentive pressurization process or any breakage on the piston seal (e.g., waterproof gasket), the piping hot solvent will splash toward the ground and the base 4 rather than splash toward the fragile parts of the human body (e.g., eyes, mouth and nose). Therefore, the safety during the extraction process of beverage is significantly improved.

(3) As mentioned above, some of the conventional manual coffee machines use devices similar to pumps as power sources. In order to achieve an ideal extraction pressure (9 bar), the user exert a force on the lever and then said force can be amplified in accordance with Principles of Levers to operate the piston. However, the amplification is still limited and depends on the length of the lever. Accordingly, the users must put lots of effort for operating the lever to create such a high pressure, which render the extraction process laborious and inconvenient. In particular, the present disclosure further includes the first transmission element 121 and the second transmission element 122. As a small gear drives a larger gear, the force exerted by the user will further be amplified to achieve a labor-saving efficacy.

(4) Similarly, in the professional field related to coffee brewing, using the same coffee bean for brewing under different pressures or using different coffee beans for brewing under the same pressure. The pressure gage of the conventional coffee machines on the market is always located close to the device similar to a pump. However, the pressure measured close to said device is not a real pressure provided for brewing. When the hot water passes through the pipelines and the components which has different bore diameters, lengths and widths, a pressure difference occurs in according with the basic principle of hydromechanics, so that it is difficult for the user to determine the real pressure for brewing. In the light of this, in the present disclosure, the pressure gage 8 is located adjacent to the third end 313, so that the pressure measured can be closer to the ideal extraction pressure that the user wants to maintain, which solves the problem of the pressure differences caused by an improper placement of pressure gage of the conventional coffee machine.

(5) After the use of the machine for extraction of beverage 9, the user may remove the container 5 connected with the first end 311 to allow the first end 311 being an open system. After that, the user may allow the storage unit 2 to create a suction to draw the air by operating the driving unit 1, in this way, the solvent that remains in the transfer unit 3 may be output to keep the transfer unit 3 clean.

(6) Besides, in some embodiments, the machine for extraction of beverage 9 may randomly connect with a common Erlenmeyer flask on the market and a common portafilter on the market, so that the user doesn't need to purchase the consumables such as the container, the portafilter, and so on, from an original manufacturer, which improves the experience and the convenience for the users.

By the way, in the embodiments of the present disclosure, the various components of the machine for extraction of beverage 9 may be selected from, for example but not limited to, sanitary food grade fittings.

In conclusion, the present disclosure provides a machine for extraction of beverage which allows a solvent to flow back and forth between the container and the storage unit or between the storage unit and the extraction unit by the use of the multi-way valve assembly, so that the solvent can be heated repeatedly to provide an ideal extraction temperature.

In addition, the machine for extraction of beverage amplifies the force exerted by a user in accordance with Principles of Levers by a configuration of a lever, a first transmission element, and a second transmission element to solve the problem of laborious extraction step.

Besides, the machine for extraction of beverage configures a piston assembly. Different from the conventional manual coffee machine, the piston assembly moves and penetrates through the bottom of the storage unit so as to prevent hazards caused by heated liquid splashing from the top side of the storage unit if there is an inattentive pressurization process or any breakage on the piston seal.

Lastly, the machine for extraction of beverage further comprises a pressure gage adjacent to the third end so as to control the ideal extraction pressure more precisely.

The above embodiment is only illustrative, and not restrictive. Any equivalent amendments or changes to the above embodiments without deviating from the spirit and scope of this disclosure should also fall within the scope of the patent application attached.

What is claimed is:

1. A machine for extraction of beverage, comprising:
a driving unit;
a storage unit connected with the driving unit; and
a transfer unit including a multi-way valve assembly, wherein the multi-way valve assembly comprises:
a first end used to connect with a container, wherein the container is used to hold a solvent; a second end connected with the storage unit; and
a third end used to connect with an extraction unit, wherein the extraction unit is used to hold an extract;
wherein when the multi-way valve assembly is under a first state, the solvent is driven by the driving unit to flow between the first end and the storage unit selectively depending on a user requirement; and when the multi-way valve assembly is under second state, the solvent is driven by the driving unit to flow between the storage unit and the third end selectively depending on a user requirement.

2. A machine for extraction of beverage, comprising:
a storage unit;
a transfer unit, including:
a first end used to connect with a container, wherein the container is used to hold a solvent; a second end connected with the storage unit;
a third end used to connect with an extraction unit, wherein the extraction unit is used to hold an extract;
a driving unit connected with the storage unit wherein the driving unit includes a lever, a transfer assembly and a piston assembly; the lever is configured to be held by a user to drive the solvent to flow within the transfer unit;
wherein the transfer assembly comprises a first transmission element and a second transmission element meshing with the first transmission element.

3. The machine for extraction of beverage according to claim 1, wherein the driving unit comprises a lever, a transfer assembly, and a piston assembly, wherein the lever is configured to be held by a user to drive the solvent to flow within the transfer unit.

4. The machine for extraction of beverage according to claim 3, wherein the transfer assembly further comprises a first transmission element and a second transmission element meshing with the first transmission element.

5. The machine for extraction of beverage according to claim 2, wherein both the first transmission element and the second transmission element are gears, and a pitch diameter of the first transmission element is shorter than a pitch diameter of the second transmission element.

6. The machine for extraction of beverage according to claim 3, wherein both the first transmission element and the second transmission element are gears, and a pitch diameter of the first transmission element is shorter than a pitch diameter of the second transmission element.

7. The machine for extraction of beverage according to claim 4, wherein both the first transmission element and the second transmission element are gears, and a pitch diameter of the first transmission element is shorter than a pitch diameter of the second transmission element.

8. The machine for extraction of beverage according to claim 2, wherein the storage unit comprises a first opening and a second opening, and the piston assembly penetrates the second opening.

9. The machine for extraction of beverage according to claim 3, wherein the storage unit comprises a first opening and a second opening, and the piston assembly penetrates the second opening.

10. The machine for extraction of beverage according to claim 8, further comprising a base, wherein compared to the second opening, the first opening is located on a side of the storage unit away from the base.

11. The machine for extraction of beverage according to claim 9, further comprising a base, wherein compared to the second opening, the first opening is located on a side of the storage unit away from the base.

12. The machine for extraction of beverage according to claim 10, wherein a direction of movement of the piston assembly and the base are perpendicular to each other.

13. The machine for extraction of beverage according to claim 11, wherein a direction of movement of the piston assembly and the base are perpendicular to each other.

14. The machine for extraction of beverage according to claim 1, further comprising a pressure gage disposed adjacent to the third end.

15. The machine for extraction of beverage according to claim 2, further comprising a pressure gage disposed adjacent to the third end.

16. The machine for extraction of beverage according to claim 1, wherein the multi-way valve assembly further comprises a multi-way valve and a multi-way tube, wherein the multi-way valve is disposed in the multi-way tube, and the multi-way tube is connected with at least one of the first end, the second end and the third end by a tubular member.

17. The machine for extraction of beverage according to claim 14, wherein the multi-way tube is a three-way pipe.

18. The machine for extraction of beverage according to claim 1, wherein the container is an Erlenmeyer flask.

19. The machine for extraction of beverage according to claim 2, wherein the container is an Erlenmeyer flask.
